(19) United States
(12) Patent Application Publication
(10) Pub. No.: US 2006/0193560 A1
(43) Pub. Date: Aug. 31, 2006

(54) Coupling structure between a fiber and a planar lightwave circuit (PLC) and manufacturing method therefor

(76) Inventors: Chien-Cheng Yang, Hsinchu (TW); Wen-Jiun Liu, Hsinchu (TW); Zhi-Cheng Hsiao, Hsinchu (TW)

Correspondence Address: RABIN & Berdo, PC, 1101 14TH STREET, NW, SUITE 500, WASHINGTON, DC, 20005, US

(21) Appl. No.: 11/407,105

(22) Filed: Apr. 20, 2006

Related U.S. Application Data
(63) Continuation-in-part of application No. 10/972,519, filed on Oct. 25, 2004.

(30) Foreign Application Priority Data
Jun. 1, 2004 (TW) 93115644

(51) Int. Cl. G02B 6/30

(52) U.S. Cl. 385/49

(57) ABSTRACT

A coupling structure between a fiber and a PLC to couple the PLC to the fiber is provided. A substrate includes a PLC region and at least one aligning groove for accommodating the fiber. The PLC region has optical circuits and input/output surfaces of the optical circuits. The input/output surfaces face the aligning groove and are at a non-perpendicular angle with respect to progressing direction of the incident light from the top view of the PLC. Therefore, the coupling loss and reflection during transmission can be effectively reduced.

### CROSS-REFERENCE TO RELATED APPLICATIONS

This application is a continuation-in-part (CIP) of U.S. patent application Ser. No. 10/972,519, filed on Oct. 25, 2004 and now pending, incorporated by reference for all purposes as if fully set forth herein.

### BACKGROUND OF THE INVENTION

1. Field of Invention

The invention relates to an optical coupling structure and its manufacturing method; in particular, to a coupling structure between a fiber and a planar lightwave circuit (PLC).

2. Related Art

Optical waveguides have many advantages such as highly stable, easy for mass production, easy to be integrated, highly sensitive, and unperturbed by electromagnetic waves. Therefore, they can be used in various kinds of environments. Planar lightwave circuits (PLC's) utilize semiconductor processes to make all kinds of optical waveguide channels on a plane in order to provide functions of beam splitting, beam merging, and optical switches. Separated devices are integrated in this way on a complete platform to reduce whole module sizes, system complexity, and signal loss, and increase the reliability and yield of the devices.

The PLC uses a silicon chip as the substrate and has three layers of materials with different indices of refraction deposited thereon. The upper and lower layers are cladding layers. The middle layer is the waveguiding layer with a higher index of refraction. How to align and couple an optical waveguide to a fiber on the waveguide chip to transmit optical signals to other optical device and to reduce losses caused by the coupling is an important subject in the field of waveguide chip designs. The coupling between fibers and optical waveguides has been improved continuously. In the beginning, the fiber-waveguide coupling is between a single-channel waveguide and a single fiber. This is easier to be implemented. However, current optical waveguides have evolved toward high-density waveguide arrays. For example, the beam splitter in the optical waveguide is used to split the beam in a fiber to multiple fibers according to predetermined proportions of optical energy. It is also called a coupler. The one-to-many structure of the beam splitter has an input optical waveguide split into several receiving optical waveguides. Therefore, the single-channel waveguide to single fiber method is infeasible.

The coupling method currently used between the PLC and the fiber is to prepare a V-shape groove on an optical waveguide chip by etching. The V-shape groove fixes the fiber so that its kernel lies along a line in order to ensure the matching with the optical waveguide array. However, when a beam enters from the fiber surface to the receiving optical waveguide and from the optical waveguide to the fiber surface, the incident light is perpendicular to the cutting surfaces of them. This generates noisy reflective light from the cutting surfaces that enters the receiving optical waveguide, resulting in non-synchronous resonance. Therefore, optical loss occurs at the alignment coupling between the optical waveguide and the fiber. This affects the optical flux into and out of optical waveguides.

In U.S. Pat. No. 5,175,781 invented by Hockaday et al., it is a method of attaching an optical fiber to an IOC (integrated optic chips). Hockaday utilizes laser ablation system to form an alignment groove for positioning a fiber as well as uses dicing saw method to form a gap between alignment groove and waveguide. Wherein the accuracy of laser ablation system is around 2 um and the core diameter of a single mode fiber is 9 um. Therefore, the accuracy of laser ablation system for this kind of application is not good enough. In addition, the roughness of dicing saw is not good enough, either. Disadvantages of this method are that they are labor intensive, cannot assure perfect alignment of fibers and plannar waveguides in all directions, and that they introduce excess losses due to a mismatch between the core size of the optical fiber and the waveguide.

In U.S. Pat. No. 6,157,759 invented by Seo et al., it discloses an optical fiber passive alignment apparatus for passively aligning an optical fiber with an input/outpur optical waveguide of an interated optical device and a method therefor. Seo uses etch or mechanical method to form the V groove for positioning a fiber and uses dicing saw or cutting tool to form a gap between wave guide and V groove. This method has the same roughness issue as that of the method Hockaday discloses.

In U.S. Pat. No. 6,665,475, a groove assembly for holding at least one fiber optic is provided. The assembly includes a base, a cover and a small carrier disposed between the base and the cover. The carrier has at least one groove. At least on fiber optic is disposes in this groove and terminates at an edge surface of the carrier. The base and cover have respective edge surfaces serving as attachment surfaces for attachment of the assembly to a planar lightwave circuit (PLC). The PLC has at least on waveguide terminating at an edge, to which the fiber requires alignment.

In U.S. Pat. No. 6,400,857 invented by Hatami-Hanza, Hatami discloses an integrated optical board made by embedding and securing optical fibers in a substrate, and excising the ends of the substrate to serve as optical connectors. Hatami shows how to accurate positioning of the waveguide with respect to embedded fiber cores.

All prior art mentioned previously discuss how to make the alignment between fibers and waveguide accurate, but not depict how to reduce coupling loss and suppress noises during the transmission process. Although Hockaday discloses that a cut into the IOC forms a planar surface normal or at an angle with respect to both an optical axis of the waveguide and an axis of the alignment groove, the angle is formed from lateral view of the IOC. This is not easy to manufacture this kind of IOC having a planar surface at an angle with respect to optical axis.

### SUMMARY OF THE INVENTION

In view of the foregoing, an objective of the invention is to provide a coupling structure between a fiber and a PLC. By preparing a PLC on a substrate and using an aligning groove, a good alignment can be achieved when the fiber is disposed in the groove to align with the PLC, effectively reducing the coupling loss. The interface between the fiber and the PLC has a non-perpendicular angle with the progressing direction of the light from top view of the PLC. This can avoid the reflection that occurs when the interface is perpendicular to the incident light and the noisy reflection at the cutting surfaces. This can effectively reduce or suppress noises during the transmission process. In addition, since the non-perpendicular angle and the cutting surfaces are formed at the same time that the PLC is formed by semiconductor photolithography process. The manufacturing process is simple and its accuracy is good.

The disclosed coupling structure couples the transmitting beam between a fiber and a PLC. It is featured in that the substrate comprises a PLC region and a plurality of aligning grooves for accommodating the fibers. The PLC region made by a process selected from the group of semiconductor photolithography process, mechanical machining and laser cutting has optical circuits and input/output (I/O) surfaces of the optical circuits. The I/O surfaces face the aligning grooves. The optical circuits aim at the positions for coupling with the optical fibers. The terminals of the optical circuits touch the I/O surfaces. A non-perpendicular angle is formed at the same time that the PLC region is formed by semiconductor photolithography process and formed between the I/O surfaces and the progressing direction of the incident light. Since the non-perpendicular angle is form at the same time that the PLC region is formed, the process to manufacturing the coupling structure is much easier than aforesaid prior art.

Moreover, the cutting surfaces of the aligning grooves and the fibers can have a non-perpendicular angle with the progressing direction of the incident light from top view of the PLC and be parallel to the I/O surfaces in the PLC region. The angle between the I/O surfaces and the progressing direction of the incident light has two preferred ranges. The angle is between 70 and 90 degrees if it is positive, whereas it is between −90 and −70 degrees if it is negative.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment of the invention;

FIG. 2 is a schematic view of the second embodiment of the invention;

FIG. 3A to 3J is a top view of a manufacturing method of the invention; and

FIG. 4A to 4J is a cross-sectional view of the manufacturing method of the invention taken at section 4A-4A to 4J-4J shown in FIG. 3A to 3J, respectively.

### DETAILED DESCRIPTION OF THE INVENTION

The invention uses optical components, for example, a beam splitter and a beam coupler, made of the PLC as embodiments. The optical path constructed from the beam splitters and the fibers along with its coupling structure is made on a substrate. It can be used in a fiber communication and other optical systems.

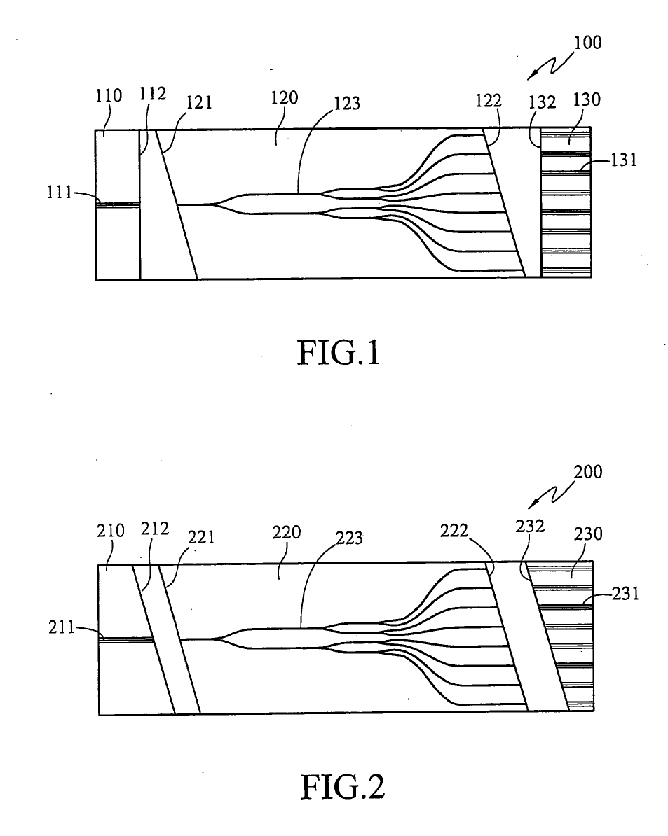

As shown in FIG. 1, a substrate 100 is formed with an optical input region 110, a PLC region 120, and an optical output region 130. The substrate 100, for instance, can be a silicon substrate. The optical input region 110 has a first aligning groove 111 for accommodating an input fiber (not shown) to transmit input beam of incident light to the PLC region 120. The optical input region 110 has an input surface 112. The cutting surfaces of the first aligning groove 111 and the input fiber touch the input surface 112. The PLC region 120 is a one-to-many beam splitter and has a first input/output (I/O) surface 121, a second I/O surface 122 and a plurality of optical circuits 123. The optical circuits 123 split the input beam transmitted from the optical input region 110 into several output beams to the optical output region 130. The optical output region 130 has several second aligning grooves 131 for accommodating several output fibers (not shown) to receive the output beams from the PLC region 120. The optical output region 130 includes a receiving surface 132. The cutting surfaces of the second aligning grooves 131 and the output fiber touch the receiving surface 132. The first I/O surface 121 faces the input surface 112 of the optical input region 110. The second I/O surface 122 faces the receiving surface 132 of the optical output region 130. The optical circuits 123 are aligned to couple the fibers. Both ends of each optical circuit 123 touch the first I/O surface 121 and the second I/O surface 122. The first I/O surface 121 and the second I/O surface 122 have an angle of about 82 degrees with respect to the progressing direction of the transmitted light from top view of the PLC region 120. As shown in FIG. 1, there is a gap formed between the fibers and each I/O surface 121, 122, for example an air gap.

The I/O surfaces of the PLC are not perpendicular to the progressing direction of the transmitted light from top view of the PLC but may have an arbitrary slant angle. Noisy reflections can thus be greatly reduced.

The input surface and the receiving surface may also have non-perpendicular angle with respect to the progressing direction of the transmitted light from top view of the PLC region 120. Here the input surface and the receiving surface are parallel to the I/O surfaces. With reference to FIG. 2, the second embodiment of the invention forms an optical input region 230, a PLC region 220 and an optical output region 210 on a substrate 200, for example, a silicon substrate. The optical input region 230 has a plurality of first aligning grooves 231 for containing a plurality of input fibers (not shown) to transmit a plurality of input beams of light to the PLC region 220. The optical input region 230 has an input surface 232. The surfaces of the first aligning grooves 231 and the input fibers touch the input surface 232. The PLC region 220 is a many-to-one beam coupler and has a first I/O surface 222, a second I/O surface 221 and a plurality of optical circuits 223. The optical circuits 223 couple the input beams transmitted from the optical input region 230 into an output beam to the optical output region 210. Both ends of each optical circuit 223 touch the first I/O surface 222 and the second I/O surface 221. The first I/O surface 222 and the second I/O surface 221 have an angle about 82 degrees with respect to the progressing direction of the transmitted light from top view of the PLC region 220.

The optical output region 210 has a second aligning groove 211 for accommodating a output fiber to receive the output beam from the PLC region 220. The optical output region 210 has a receiving surface 212. The cutting surfaces of the second aligning groove 211 and the output fiber touch the receiving surface 212. The input surface 232 of the optical input region 230 is parallel to the first I/O surface 222. The receiving surface 212 of the optical output region 210 is parallel to the second I/O surface 221. Each of the optical circuits 223 is aligned to couple to the corresponding fiber. As shown in FIG. 2, there is a gap formed between the fibers and each I/O surface 121, 122. The gap can be an air gap.

The input surface, the receiving surface, and the I/O surfaces of the disclosed coupling structure between a fiber and a PLC can be formed using the semiconductor photolithography process with appropriate masks, followed by etching, or any other machining, or laser cutting. There are two preferred ranges of the angle between the I/O surfaces and the progressing direction of the incident light. The angle is between 70 and 90 degrees if it is positive, whereas it is between −90 and −70 degrees when it is negative. In the current embodiment, the angle is 82 degrees. Of course, it can be −82 degrees.

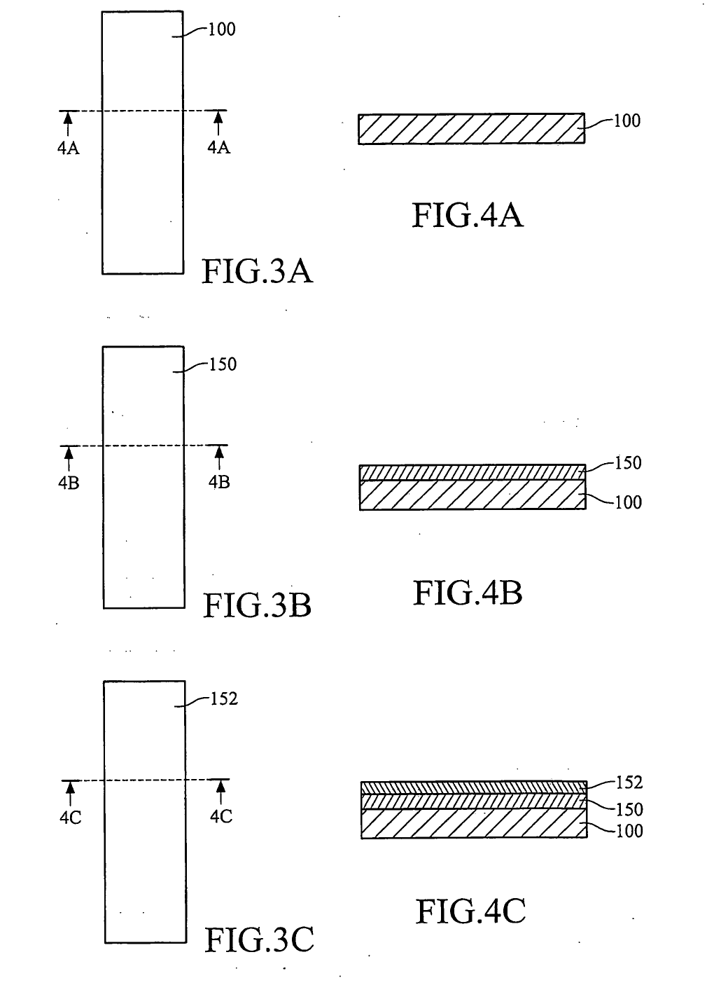

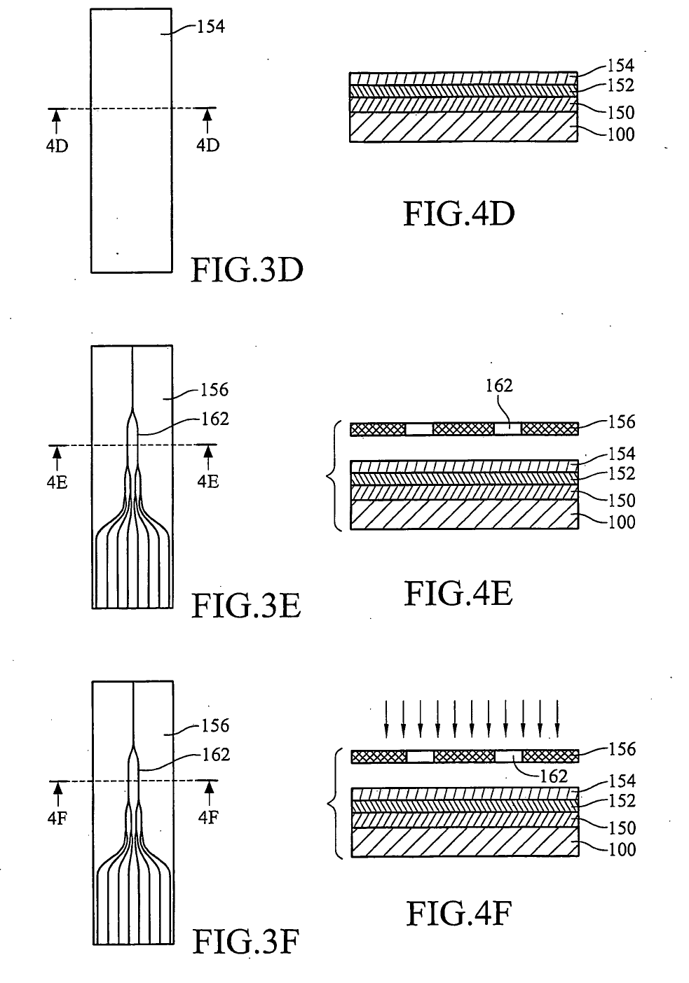

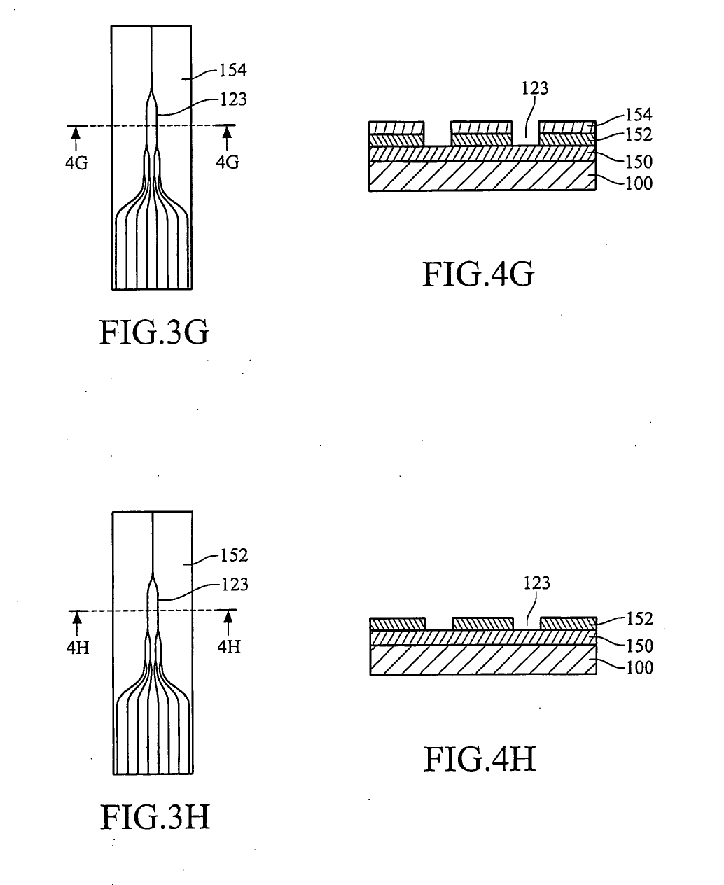

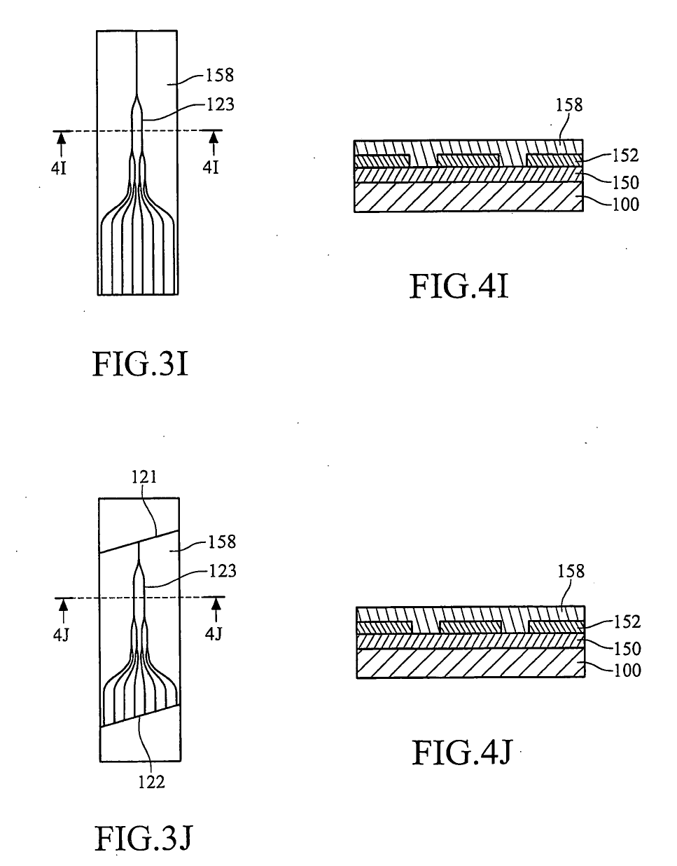

As for the method of manufacturing the coupling structure, taking photolithography semiconductor process as an example, please refer to FIG. 3A to 3J and FIG. 4A to 4J. The method comprises that provide a substrate 100 as shown in FIGS. 3A and 4B, for example, a silicon substrate. Then, form a bottom cladding layer 150 on the substrate 100 as shown in FIGS. 3B and 4B. The material of bottom cladding layer 150 can be liquid glass such as sol-gel solution. Next, form a core layer 152 on the bottom cladding layer 150 as shown in FIG. 3C and FIG. 4C. Then, coat a resist layer 154 on the core layer 152 as shown in FIG. 3D and FIG. 4D. Mask a mask 156 with waveguide circuitry 162 as shown in FIGS. 3E and 4E. Next, expose to the mask 156 and remove the mask 156 as shown in FIGS. 3F and 4F. Then, etch core layer to form a waveguide circuitry on the core layer 152 as shown in FIGS. 3G and 4G. Remove the resist layer 154 from the core layer 152 as shown in FIGS. 3H and 4H. Next, form a top cladding layer 158 on the core layer 152 and the bottom cladding layer 150 as shown in FIGS. 31 and 41. Etch two air gaps to form the first I/O surface 121 and second I/O surface 122 as shown in FIGS. 3J and 4J. The I/O surfaces 121 and 122 are at an angle with respect to the axis of light progressing from the top view of the PLC.

Besides, the I/O surfaces 121 and 122 can be formed by a process selected from the group consisting of photolithography semiconductor process, mechanical machining and laser cutting. Therefore, the angle between the I/O surfaces 121 and 122 and the axis of light progressing from the top view of the PLC can be easily created. In comparison with the angle from lateral view of PLC, the invention provides more accurate and convenient manufacturing process to the coupling structure between a fiber and a PLC.

While the preferred embodiments of this invention have been set forth for the purpose of disclosure, modifications of the disclosed embodiments of the invention as well as other embodiments thereof may occur to those skilled in the art. Accordingly, the appended claims are intended to cover all embodiments which do not depart form the scope of this invention.

What is claimed is:

1. An optical component structure, comprising:
an optical input region, having a plurality of first aligning grooves for accommodating input fibers to transmit input beams of light;
a planar lightwave circuit (PLC) region, having a first input/output (I/O) surface, a second I/O surface and a plurality of optical circuits, the plurality of optical circuits coupling the input beams received from the optical input region into a output beam; and
an optical output region, having a second aligning groove for accommodating a output fiber to receive the output beam;
wherein the both ends of each of the optical circuits touch the first I/O surface and the second I/O surface and each of the optical circuits is aligned to couple to the fiber, the first I/O surface and the second I/O surface having a non-perpendicular angle with respect to the progressing direction of the transmitted light from the top view of the PLC.

2. The optical component structure of claim 1, wherein the optical input region has an input surface facing the first I/O surface, and the cutting surfaces of the first aligning grooves and the input fibers touch the input surface.

3. The optical component structure of claim 2, wherein the cutting surfaces of the first aligning grooves and the input fibers are parallel to the I/O surface.

4. The optical component structure of claim 1, wherein the optical output region has a receiving surface facing the second I/O surface, and the cutting surfaces of the second aligning groove and the output fiber touch the receiving surface.

5. The optical component structure of claim 4, wherein the cutting surfaces of the second aligning groove and the output fiber are parallel to the I/O surface.

6. The optical component structure of claim 1, wherein the angle is between 70 and 90 degrees.

7. The optical component structure of claim 1, wherein the angle is between −90 and −70 degrees.

8. The optical component structure of claim 1, wherein the I/O surface is formed using a process selected from the group consisting of photolithography, mechanical machining and laser cutting.

9. The optical component structure of claim 1, wherein a gap is between the fibers and each I/O surface.

10. The optical component structure of claim 9, wherein the gap is an air gap.

11. An optical component structure, comprising:
an optical input region, having a first aligning groove for accommodating an input fiber to transmit an input beam of light;
a planar lightwave circuit (PLC) region, having a first input/output (I/O) surface, a second I/O surface and a plurality of optical circuits, the plurality of optical circuits splitting the input beam received from the optical input region into output beams; and
an optical output region, having a plurality of second aligning grooves for accommodating a plurality of fibers to receive the output beams;
wherein the both ends of each of the optical circuits touch the first I/O surface and the second I/O surface and each of the optical circuits is aligned to couple to the fibers, the first I/O surface and the second I/O surface having a non-perpendicular angle with respect to the progressing direction of the transmitted light from the top view of the PLC.

12. The optical component structure of claim 11, wherein the optical input region has an input surface facing the first I/O surface, and the cutting surfaces of the first aligning groove and the input fiber touch the input surface.

13. The optical component structure of claim 12, wherein the cutting surfaces of the first aligning groove and the input fiber are parallel to the I/O surface.

14. The optical component structure of claim 11, wherein the optical output region has a receiving surface facing the second I/O surface, and the cutting surfaces of the second aligning grooves and the output fibers touch the receiving surface.

15. The optical component structure of claim 14, wherein the cutting surfaces of the second aligning grooves and the output fibers are parallel to the I/O surface.

16. The optical component structure of claim 11, wherein the angle is between 70 and 90 degrees.

17. The optical component structure of claim 11, wherein the angle is between −90 and −70 degrees.

18. The optical component structure of claim 11, wherein the I/O surface is formed using a process selected from the group consisting of photolithography, mechanical machining and laser cutting.

19. The optical component structure of claim 11, wherein a gap is between the fibers and each I/O surface.

20. The coupling structure between a fiber and a PLC of claim 19, wherein the gap is an air gap.

21. A coupling structure, comprising:
at least one fiber to transmit light;
at least one aligning groove accommodating the fiber; and
a planar lightwave circuit (PLC) region having an optical circuit and at least one input/output (I/O) surface, the I/O surface facing the aligning groove, the terminal end of the optical circuit touching the I/O surface, the optical circuit being aligned to couple to the fiber, and the I/O surface having a non-perpendicular angle with respect to the progressing direction of the transmitted light from top view of the PLC region.

22. The coupling structure of claim 21, wherein the cutting surfaces of the aligning groove and the fiber are parallel to the I/O surface.

23. The coupling structure of claim 21, wherein the angle is between 70 and 90 degrees.

24. The coupling structure of claim 23, wherein the angle is 82 degrees.

25. The coupling structure of claim 21, wherein the angle is between −90 and −70 degrees.

26. The coupling structure of claim 25, wherein the angle is −82 degrees.

27. The coupling structure of claim 21, wherein the I/O surface is formed using a process selected from the group consisting of photolithography, mechanical machining and laser cutting.

28. The coupling structure of claim 21, wherein a gap is between the fiber and the I/O surface.

29. The coupling structure of claim 28, wherein the gap is an air gap.
